(19) United States
(12) Patent Application Publication
(10) Pub. No.: US 2007/0253284 A1
(43) Pub. Date: Nov. 1, 2007

(54) Shaker device for analyzer apparatus and analyzer comprising same

(75) Inventors: Siegfried Muller, Meierskappel (CH); Ueli Stettler, Cham (CH)

Correspondence Address: ROCHE MOLECULAR SYSTEMS INC;PATENT LAW DEPARTMENT, 1145 ATLANTIC AVENUE, ALAMEDA, CA, 94501, US

(73) Assignee: ROCHE MOLECULAR SYSTEMS, INC., Alameda, CA (US)

(21) Appl. No.: 11/418,440

(22) Filed: May 3, 2006

(30) Foreign Application Priority Data
Apr. 28, 2006 (EP) 06008848.1

(51) Int. Cl. B01F 11/00

(52) U.S. Cl. 366/208

(57) ABSTRACT

A shaker device for shaking liquids in a clinical chemistry analyzer comprises an eccentric pin on a rotatable disk, a motor for rotating the disk and a movable piece having a joint for receiving the eccentric pin. The movable piece is mounted on a first movable part of a first linear motion guide having a first rail on which the first movable part can slide in a first direction (Y-direction). The first rail of the first linear motion guide is mounted on an intermediate plate which is mounted on a second movable part of a second linear motion guide having a second rail on which the second movable part can slide in a second direction (X-direction) which is normal to the first direction.

### BACKGROUND OF THE INVENTION

1. Field of the Invention

The invention concerns a shaker device used as part of a clinical chemistry analyzer.

The invention also concerns an automatic analyzer comprising a shaker device.

Some of the liquids used in automatic clinical chemistry analyzers require agitation during predetermined time intervals, whereas other required liquids require no agitation at all. Liquids which require agitation during predetermined time intervals are e.g. solutions containing magnetic particles, which should be uniformly distributed in the solution. Shaker devices suitable for performing the required agitation are thus a necessary part of automatic clinical chemistry analyzers.

2. Description of Related Art

In prior art previously, it has been necessary to have additional racks for containers which contain liquids that require agitation and a shaker device connectable to such racks or, alternatively, to selectively transport such containers to a shaker station for agitating liquid containers and thereby the liquids contained therein. A disadvantage of both approaches is that they increase the complexity and the manufacturing cost of automatic clinical chemistry analyzers. It is therefore desirable to have racks and analyzers which do not have this disadvantage.

### SUMMARY OF INVENTION

A first aim of the invention is therefore to provide a shaker device suitable for being used as part of a clinical chemistry analyzer.

A second aim of the invention is to provide an analyzer which comprises a shaker device connectable to a rack for liquid containers and which makes it possible to eliminate the above mentioned disadvantages.

According to a first aspect of the invention, a shaker device comprising an eccentric pin on a rotatable disk, a motor for rotating the disk, a movable piece having a joint for receiving the eccentric pin, wherein the movable piece is mounted on a first movable part of a first linear motion guide having a first rail on which the movable part may slide in a first direction (Y-direction), and wherein the first rail of the first linear motion guide is mounted on an intermediate plate which is mounted on a second movable part of a second linear motion guide having a second rail on which the second movable part can slide in a second direction (X-direction) which is normal to said first direction.

According to a second aspect of the invention an automatic analyzer comprising a shaker device wherein the movable piece is a tray adapted for receiving a liquid container or a holder of liquid containers.

According to the third aspect of the invention an automatic analyzer comprising a rack for holding containers containing liquids comprising a frame having two or more sections, each section being adapted for receiving a liquid containing component, at least one of the sections of the frame being adapted for receiving a first liquid containing component which is adapted for being removably but tightly mechanically connected to said frame, at least one movable part adapted to be removably coupled to a shaker device, the latter movable part being adapted for receiving and holding a second liquid containing component, and a shaker device, wherein the movable piece of the shaker device and the movable part of the rack are adapted to be removably connected with each other.

The subject invention will now be described in terms of its preferred embodiments with reference to the accompanying drawings. These embodiments are set forth to aid the understanding of the invention, but are not to be construed as limiting the scope of the claims therein.

### BRIEF DESCRIPTION OF THE FIGURES

FIG. 1 shows a perspective view of a first embodiment shaker device according to the invention.

FIG. 2 shows a top plan view of the shaker device shown by FIG. 1.

FIG. 3 shows a cross-sectional view of the shaker device of FIG. 1 taken along a plane A-A in FIG. 2.

FIG. 4 shows a cross-sectional view of the shaker device of FIG. 1 taken along a plane B-B in FIG. 3.

FIG. 5 shows a perspective view of a rack according to the invention.

FIG. 6 shows an exploded view of rack shown by FIG. 5, movable part of rack and a casing containing several containers which each contain a liquid to be agitated.

FIG. 7 shows a perspective view of the shaker device shown by FIG. 1 with its coupling member connected to the movable part of rack in FIG. 5.

FIG. 8 illustrates the use of a shaker device of the type shown by FIGS. 1-4 in an analyzer comprising a rack of the type described with reference to FIGS. 5 and 6.

FIG. 9 shows a perspective view of a second embodiment of a shaker device according to the invention.

FIG. 10 shows a top plan view of the shaker device shown by FIG. 9.

FIG. 11 shows a cross-sectional view of the shaker device of FIG. 9 taken along a plane E-E in FIG. 10.

### DETAILED DESCRIPTION OF PREFERRED EMBODIMENTS

An automatic clinical chemistry analyzer comprises in general means for handling liquids like biological samples or reagents and means for analyzing sample-reagent-mixtures or mixtures comprising combinations of different samples with each other, a different reagent with each other. A reagent can be e.g. a liquid containing magnetic particles.

In the following description only those parts of an automatic clinical chemistry analyzer are described which are necessary to describe how liquid containers are agitated by means of a shaker device according to the present invention, which is part of the analyzer.

### EXAMPLES

### Example 1

### Example of a First Embodiment of a Shaker Device According to the Invention

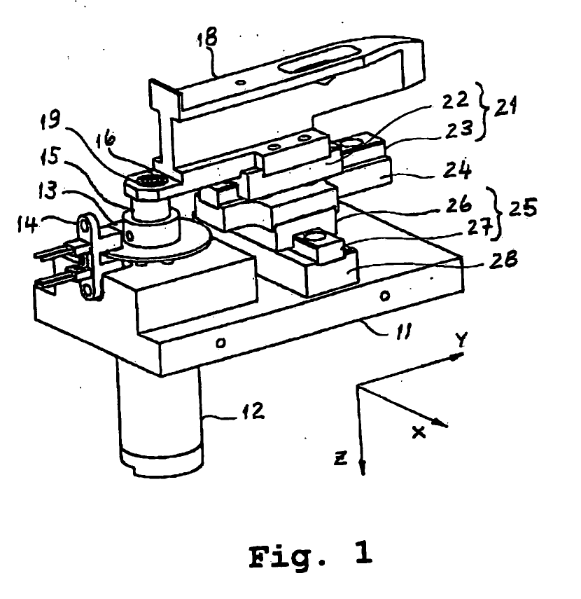

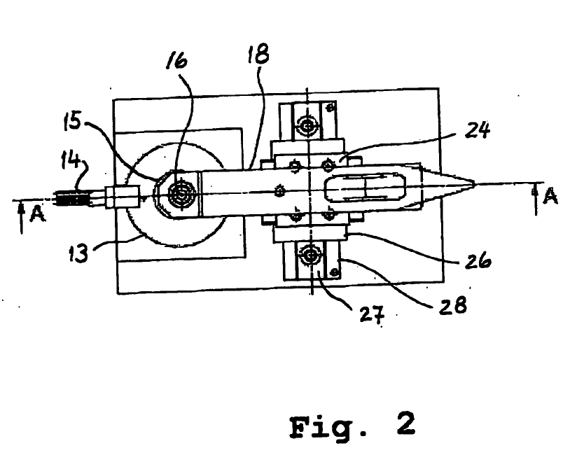

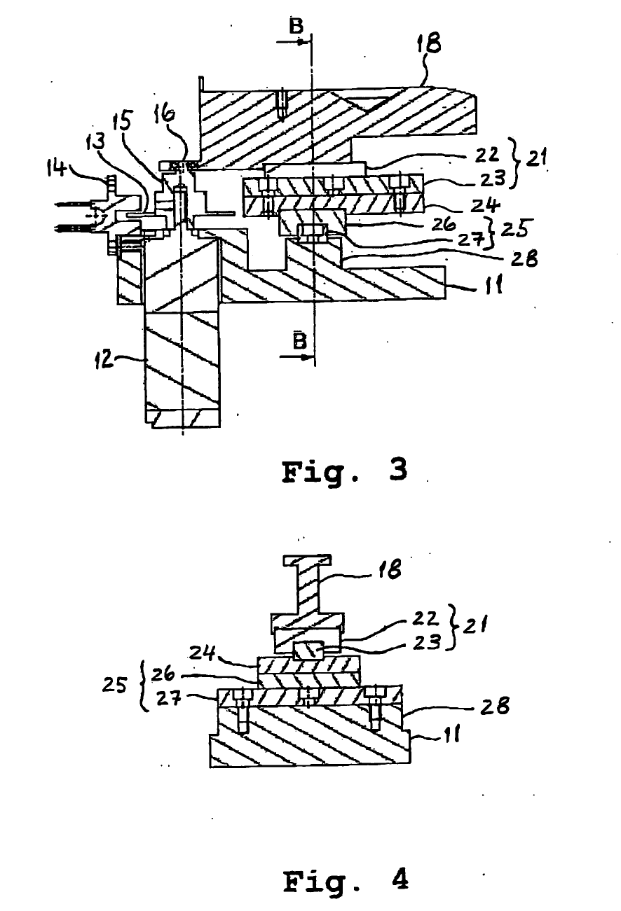

FIGS. 1 to 4 show a first embodiment of a shaker device according to the invention.

As shown by FIGS. 1 to 4, the shaker device comprises a rotatable disk 15 having an eccentric pin 16, a motor 12 for rotating disk 15 and thereby eccentric pin 16, and a movable piece 18 having a joint 19 for receiving said eccentric pin 16.

Motor 12 is mounted on a support plate 11.

The angular position of motor 12 is controlled by means of an encoder connected with motor 12 and is arranged in the housing of motor 12. The encoder receives signals from an electro-optical position detector which include various elements such as a light barrier detector 14 and a coded disk 13. Control of the angular position of motor 12 by means of the encoder and the position detector makes it possible to position a liquid container carrier and thereby liquid containers on that carrier in a reproducible way, at a predetermined position, e.g. at the end of a shaking operation of shaker device.

Movable piece 18 is mounted on a movable part 22 of a first linear motion guide 21 having a rail 23 on which movable part 22 can slide in Y-direction shown in FIG. 1, and rail 23 is mounted on an intermediate plate 24. Intermediate plate 24 is mounted on a movable part 26 of a second linear motion guide 25 having a rail 27 on which movable part 26 can slide in X-direction shown in FIG. 1. The X-direction is normal to the Y-direction. Rail 27 is mounted on a support 28 which is part of or permanently connected to support plate 11.

The intermediate plate is preferably made of a metal with low specific mass, e.g. aluminum.

Linear motion guides 21 and 25 provide accurate linear motion with low friction.

In a preferred embodiment linear motion guides 21 and 25 have sliding contact linear motion bearings.

In another preferred embodiment linear motion guides 21 and 25 have rolling element linear motion bearings, e.g. with balls as rolling elements, wherein the balls recirculate as the movable part of the linear motion guide moves along the rail thereof. Such linear motion guides are commercially available from THK Co. Ltd.

Movable piece 18 has a shape adapted for being removably connected to a movable part 35 of a rack 31 described hereinafter in Example 2.

When motor 12 rotates disk 15 and thereby eccentric pin 16, movable piece 18 is driven by pin 16 in a circular motion which results of a combination of displacements of movable piece 18 in X- and Y-direction as movable part 22 of the first linear motion guide 21 moves along rail 23 and movable part 26 of the second linear motion guide 25 moves along rail 27.

In preferred embodiments motor 12 rotates at a rotation speed comprised e.g. between 500 and 1200 rpm.

According to the invention, the circular motion of movable piece 18 is used for agitating liquids in containers as described hereinafter in Examples 2 and 3.

### Example 2

### Example of a First Embodiment of Analyzer According to the Invention

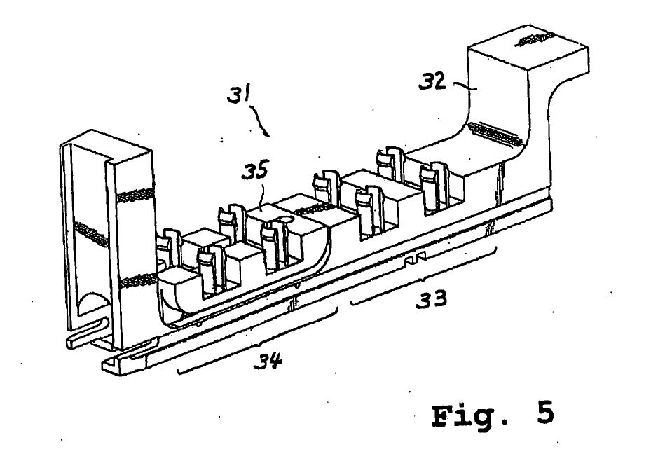

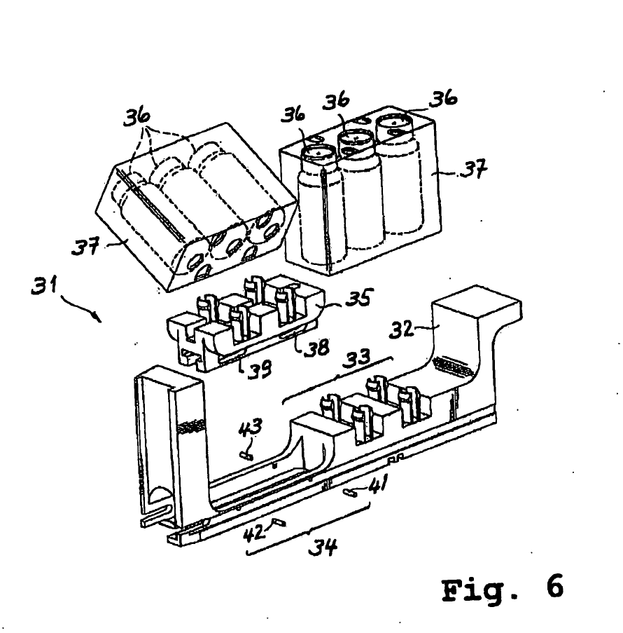

This embodiment of an analyzer comprises a rack 31 of the type shown by FIGS. 5 and 6 and a shaker device of the type described in Example 1.

As shown by FIGS. 5 and 6, rack 31 has a frame 32 and a movable part 35. Frame 32 has at least one section 33 for holding a first liquid containing component (not shown) which does not have to be agitated and at least one section 34 for holding a second liquid containing component (not shown) which has to be agitated. The movable part 35 of the rack 31 is located in a section 34. The shape and size of section 34 allows movement of movable part 35 within predetermined limits.

Rack 31 may be made of any suitable material, for instance a polycarbonate (PC).

The first and the second liquid containing components may be a single liquid container or a component comprising a casing 37 which contains one or more liquid containers 36 (see FIG. 6). A component of the latter type is described in European Patent Application EP 0564970 A2.

FIG. 6 shows a rack 31 having a section 34 that holds a liquid containing a component of the type described in European Patent Application EP 0564970 A2. Such a component comprises e.g. a casing 37 wherein one or more containers 36 are lodged. Each of the containers 36 contains a liquid to be agitated.

Movable part 35 has a shape adapted to be removably connected with the movable piece 18 of the shaker device described in Example 1.

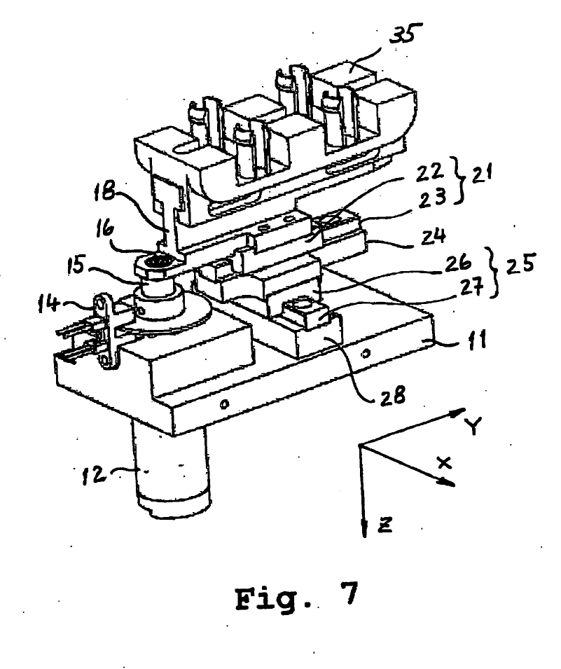

FIG. 7 shows movable part 35 of rack 31 connected with movable piece 18 of the shaker device.

When movable part 35 of rack 31 is connected with movable piece 18 of the shaker device, movable part remains loosely connected with rack 31. This loose connection is achieved by means of pins 41, 42, 43 which cooperate with corresponding openings 38, 39 of removable part 35 shown in FIG. 6. Pins 41, 42, 43 are inserted in suitable openings of frame 32.

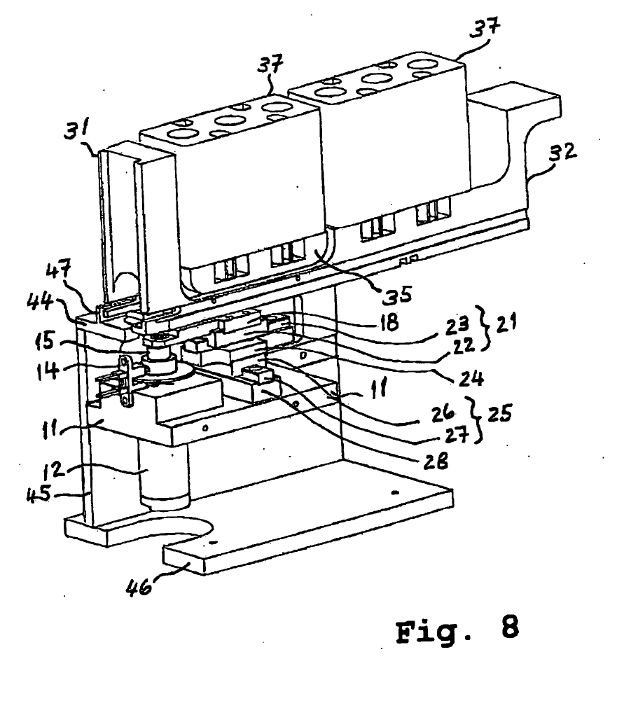

FIG. 8 shows a portion of the analyzer including structure elements on which rack 31 and the shaker device are mounted.

A support plate 44 includes guides 47 for receiving and accurately positioning rack 31 in the analyzer.

Support plate 44 and support plate 11 are mounted on a support wall 45 which in turn is mounted on a basis plate 46.

When motor 12 rotates disk 15 and thereby eccentric pin 16, movable piece 18 is driven by pin 16 in a circular motion and transmits this motion to movable part 35 of rack 31, and thereby agitates liquids in containers 36 carried by a carrier 37 arranged on movable part 35 of rack 31.

### Example 3

### Example of a Second Embodiment of an Analyzer According to the Invention

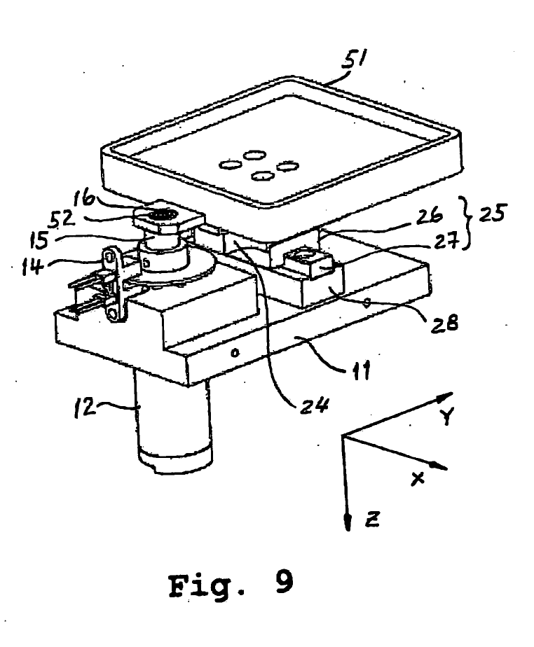

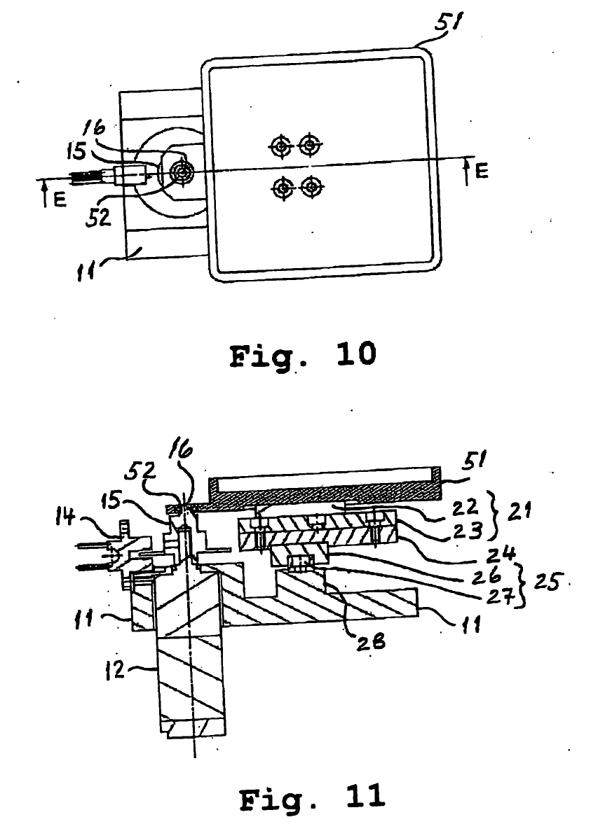

The structure of this second analyzer embodiment is similar to the structure of the first embodiment described above with reference to FIGS. 1-8, but this second analyzer embodiment comprises a second embodiment of a shaker device which is described hereinafter with reference to FIGS. 9 to 11.

The structure and operation of the shaker device shown by FIGS. 9 to 11 is similar to the structure and operation of the shaker device described with reference to FIGS. 1 to 4, but differs therefrom in that it has a movable piece 51 which is itself adapted for being used as carrier of liquid containers that have to be agitated.

When motor 12 rotates disk 15 and thereby eccentric pin 16, movable piece 18 is driven by pin 16 in a circular motion and transmits this motion directly to liquid containers arranged on movable piece 51, and thereby agitates liquids in those containers.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed:

1. A shaker device for shaking liquids in a clinical chemistry analyzer, comprising:
(a) an eccentric pin on a rotatable disk,
(b) a motor for rotating said disk,
(c) a movable piece having a joint for receiving said eccentric pin,
(d) said movable piece being mounted on a first movable part of a first linear motion guide having a first rail on which said movable part can slide in a first direction (Y-direction), and
(e) said first rail of said first linear motion guide being mounted on an intermediate plate which is mounted on a second movable part of a second linear motion guide having a second rail on which said second movable part can slide in a second direction (X-direction) which is normal to said first direction.

2. A shaker device according to claim 1, wherein said movable piece is a tray adapted for receiving a liquid container or a holder of liquid containers.

3. An automatic analyzer for analyzing biological samples, said analyzer comprising a shaker device according to claim 1, wherein said movable piece is a tray adapted for receiving a liquid container or a holder of liquid containers.

4. An automatic analyzer for analyzing biological samples, said analyzer comprising:
(a) a rack for holding containers containing liquids, said rack comprising
(1) a frame having two or more sections, each section being adapted for receiving a liquid containing component,
at least one of the sections of said frame being adapted for receiving a first liquid containing component which is adapted for being removably but tightly mechanically connected to said frame,
(2) at least one movable part adapted to be removably coupled to a shaker device, the latter movable part being adapted for receiving and holding a second liquid containing component, and
(b) a shaker device according to claim 1, wherein said movable piece of the shaker device and said movable part of said rack are adapted to be removably connected with each other.
